(19) United States
(12) Patent Application Publication
(10) Pub. No.: US 2002/0052843 A1
(43) Pub. Date: May 2, 2002

(54) Smart card for and method of executing transactions

(76) Inventor: Eduardo Gomez Canon, Montevideo (UY)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/917,725

(22) Filed: Jul. 31, 2001

Related U.S. Application Data
(60) Provisional application No. 60/222,926, filed on Aug. 4, 2000.

(51) Int. Cl. G06F 17/60

(52) U.S. Cl. 705/41

(57) ABSTRACT

A smart card for executing a plurality of transaction types. The smart card has a card substrate, and a microchip embedded in the card substrate. The smart card also includes a magnetic medium on the card substrate. The at least one of the microchip and the magnetic medium contains information for executing a plurality of transaction types, which includes at least a medical transaction, a financial transaction, and an e-commerce transaction.

### CROSS REFERENCE TO RELATED APPLICATIONS

The present non-provisional application claims the benefit of provisional application ser. No. 60/222,926, filed Aug. 4, 2000. The contents of this provisional application are hereby incorporated by reference.

### BACKGROUND OF THE INVENTION

The present invention is directed to a smart card that combines various functions, for example, a health card, a credit/debit card, and a “virtual” card, and a method for conducting various transactions.

FIG. 1 illustrates a conventional card 1 with a built in microchip 2 for executing financial transactions only. In recent years, conventional cards 1 embedded with a microchip 2 have been issued to the consumer market. The microchip 2 embedded in the conventional card 1, however, contains exclusively financial information for executing solely financial/banking transactions. In other words, the conventional card 1 cannot be used to execute any other transactions since no information/data other than financial information/data are stored thereon.

Furthermore, consumer Credit Cards as well as banking Debit Cards have also been issued to the mass market in recent years. The Credit Card and Debit Card each serves one particular purpose and can not serve to have a plurality of functions and utility. In other words, the conventional consumer Credit Card is exclusively used to purchase consumer goods and services on credit, and can not store for example, medical information for the paramedics in a medical emergency situation. Also, the Debit Card is solely used to conduct banking transactions. In particular, the conventional Debit Card is used for cash withdrawals, depositing of funds, and balance inquires; and is typically used with an Automatic Teller Machine (ATM) or a Point of Sale transaction. Accordingly, the conventional Debit Card cannot also store, for example, medical information thereon or execute e-commerce transactions on the Internet or the World Wide Web (WWW).

As such, the conventional card 1, the conventional Credit Card and Debit Card are limited in their functions as well as its utility. Accordingly, the conventional card 1, Credit Card and Debit Card do not have versatility causing the consumer to require a plurality of cards to meet the consumer's needs.

### BRIEF SUMMARY OF THE INVENTION

In one embodiment, the present invention includes a smart card for executing a plurality of transaction types. The smart card could have: a card substrate, a microchip embedded in the card substrate, and a magnetic medium on the card substrate. The at least one of the microchip and the magnetic medium contains information for executing the plurality of transaction types.

In another embodiment, the plurality of transaction types includes a medical transaction, a financial transaction, and an e-commerce transaction.

In another embodiment, the microchip contains medical information for executing the medical transaction.

In another embodiment, the medical information includes medicinal prescriptions.

In another embodiment, the microchip contains e-commerce information for executing the e-commerce transaction on the Internet or the World Wide Web (WWW).

In another embodiment, the magnetic medium contains financial information for executing the financial transaction.

In another embodiment, the smart card of the present invention further includes a graphical depiction of a proprietor placed on the smart card.

In another embodiment, the microchip could contain security information for prohibiting unauthorized access to the information contained on the smart card.

In another embodiment, the security information could include a digital signature.

In another embodiment, the microchip could contain bonus rewards information based on the execution of the plurality of transaction types.

In another embodiment, the present invention could include a method of executing a plurality of transaction types with a smart card. The method includes the steps of executing a first transaction type by, inserting the smart card into a first receptacle of a first card processing unit, receiving a first transaction decision based on information of the first transaction type, obtaining the smart card from the first card processing unit, and executing a second transaction type by, formulating a desired second transaction type, availing information of the second transaction type stored on the smart card, authorizing the execution of the second transaction type, and obtaining the smart card, and executing a third transaction type by, formulating a desired third transaction type, inserting the smart card into a second receptacle of a second card processing unit, viewing information of the third transaction type on a display, inputting an authenticating code, transmitting the information of the third transaction type and the authenticating code to a server; receiving a confirmation of the desired third transaction type, and retrieving the smart card from the second processing unit.

In another embodiment, the steps of executing the first transaction type further comprises the steps of describing a basis for executing the first transaction type, and receiving the first transaction decision based on information of the first transaction type and the basis for executing the first transaction type.

In another embodiment, the present invention includes a method step of executing the first transaction type wherein the first transaction type is a medical transaction.

In another embodiment, the steps of executing the first transaction type further comprises the step of availing the smart card to an health care service provider.

In another embodiment, the steps of executing the first transaction type further comprises the step of obtaining the smart card from the first card processing unit having updated information of the first transaction type.

In another embodiment, the steps of executing the first transaction type further comprises the step of accessing the health care service provider through an Internet Health Vertical Portal (IHVP), wherein the IHVP is configured on the Internet or the WWW.

In another embodiment, the steps of executing the first transaction type further comprises the step of scheduling an appointment with the health care service provider via the IHVP.

In another embodiment, the steps of executing the first transaction type further comprises the step of scheduling an appointment with the health care service provider.

In another embodiment, the present invention is a method further comprising the steps of executing the second transaction type wherein the second transaction type is a financial transaction.

In another embodiment, the steps of executing the second transaction type further comprises the step of passing the smart card through a magnetic medium reader such that the information of the second transaction type stored on the smart card is read by the magnetic medium reader.

In another embodiment, the steps of executing the second transaction type further comprises the step of formulating the desired second transaction type, wherein the desired second transaction type is to purchase a consumer product or service.

In another embodiment, the steps of executing the second transaction type further comprises the steps of inserting the smart card in an opening of an Automatic Teller Machine (ATM), inputting a Personal Identification Number from an input unit of the ATM, selecting the desired second transaction type from a plurality of second transaction types, commencing the desired financial transaction type, and retrieving the smart card from the ATM.

In another embodiment, the present invention is method further having the step of executing the third transaction type wherein the third transaction type is an e-commerce transaction.

In another embodiment, the steps of executing the third transaction type further comprises the step of transmitting the information of the third transaction type and the authenticating code to a server configured on the Internet or the WWW.

In another embodiment, the steps of executing the third transaction type further comprises the step of formulating the desired third transaction type wherein the desired third transaction type is to purchase a consumer product or service through the Internet or WWW.

### BRIEF DESCRIPTION OF THE DRAWINGS

FIG. 1 illustrates the a conventional card embedded with a built in microchip.

FIG. 2(a) illustrates the front side of a smart card in accordance to the invention.

FIG. 2(b) illustrates the back side of a smart card in accordance to the invention.

FIG. 3 is a diagram illustrating a smart card for executing medical, financial and e-commerce transactions, according to the invention.

FIGS. 4 and 5 show a flow chart illustrating the method of executing a medical transaction with a smart card, according to the invention.

FIG. 6 is flow chart illustrating the method of executing a financial transaction with a smart card, according to the invention.

FIGS. 7 and 8 show a flow chart illustrating the method of executing an e-commerce transaction with a smart card.

FIG. 9 shows a Smart Card Processing Unit.

FIG. 10 is a schematic diagram showing the Smart Card Patient Data System.

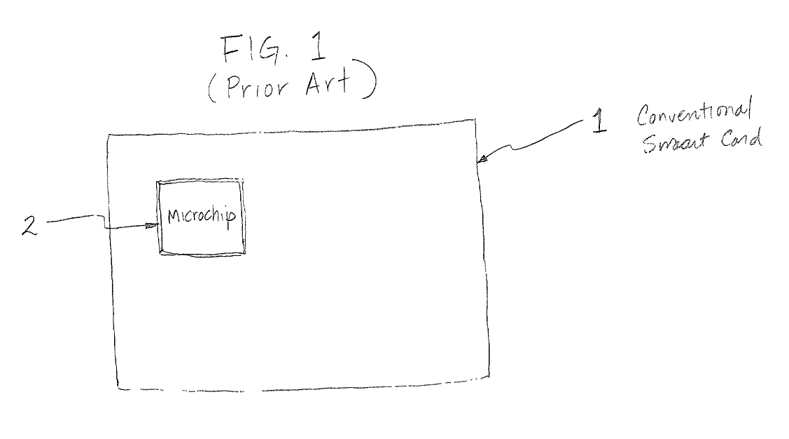

### DETAILED DESCRIPTION OF THE PREFERRED EMBODIMENTS OF THE INVENTION

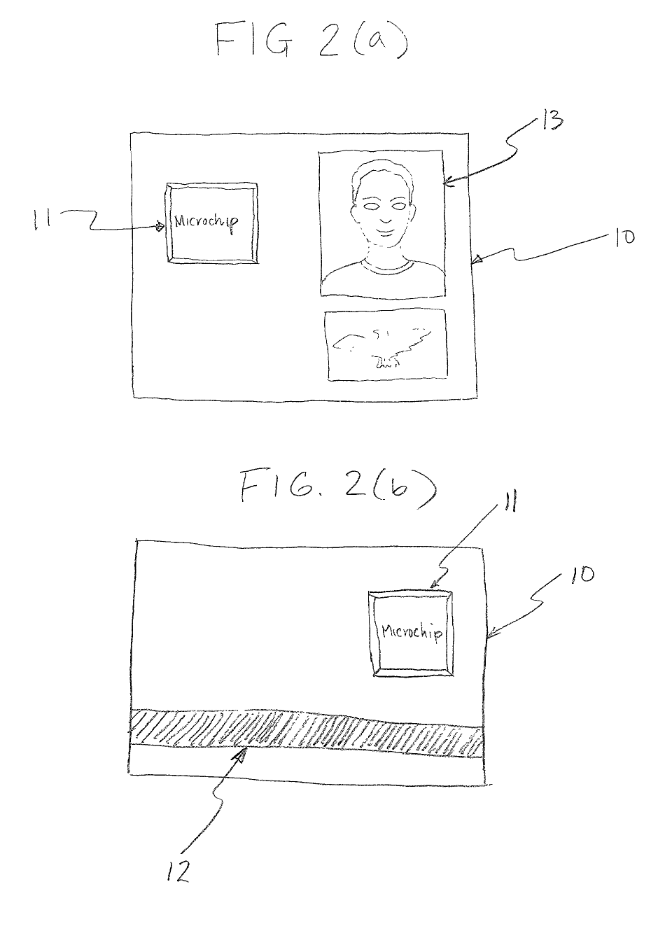

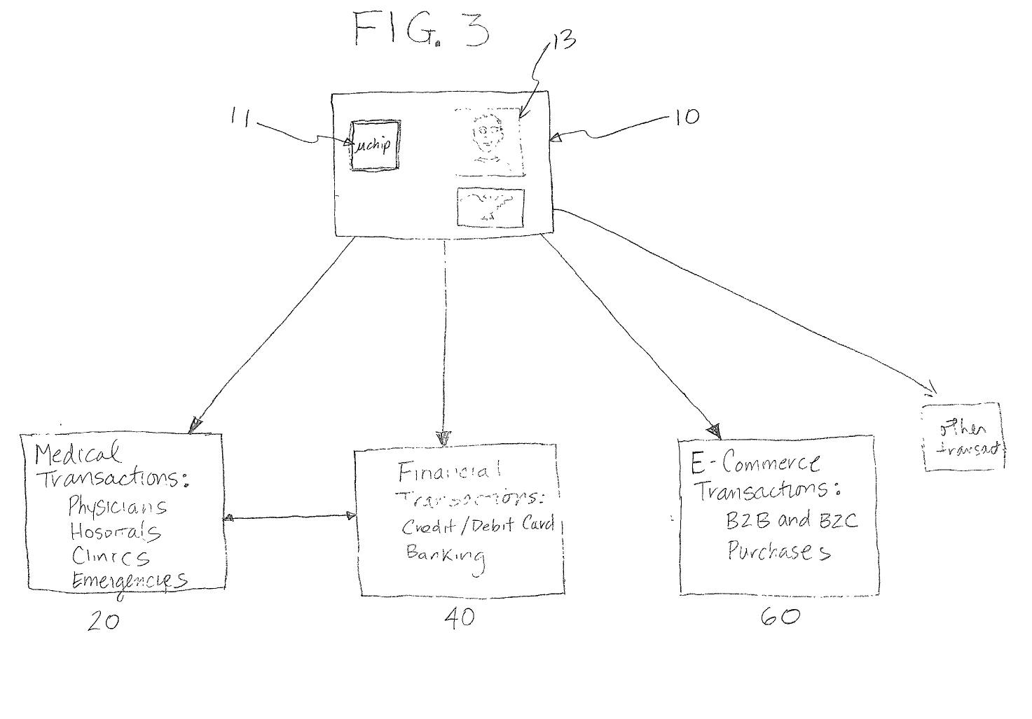

FIGS. 2(a) and 2(b) illustrate one example of a smart card 10 according to the present invention that combines a plurality of functions, such as a health card, a credit/debit card, and a “virtual” card all in one card. FIG. 2(a) shows one example of the front side of the smart card 10, and FIG. 2(b) shows one example of the back side of the smart card 10. Additionally, FIGS. 3-7 illustrate examples of a method for executing various transactions including medical, financial and e-commerce transactions 20, 40, 60 with the smart card 10. In other words, the present invention is a smart card 10 having a microchip 11 embedded therein that contains the proprietor's personal medical information for executing transactions with the medical/health community. The smart card 10 could also contain financial/banking information that allows the proprietor to execute commercial/banking transactions. Furthermore, the smart card 10 of the present invention could contain e-commerce information permitting the proprietor to execute transactions on the World Wide Web (WWW) or on the Internet. One example of such a transaction is to purchase consumer goods and services on the WWW or the Internet.

As show in FIGS. 2(a) and 2(b), one example of the smart card 10 of the present invention could contain a microchip 11 embedded therein that stores the proprietor's medical history. For instance, the medical history stored on the microchip 11 could include data and records generally kept by the medical/health community with respect to a particular patient. As an example, the microchip 11 could hold information kept by hospitals and doctors regarding the proprietor's medical treatments, medical test results, insurance information, and special medical needs. Also, the microchip 11 could store prescription drugs information which could be made available to participating pharmacies. Furthermore, personal information about the proprietor's medical/health conditions, such as diets, allergies, blood type, height and weight could further be kept in the microchip 11.

Also shown in FIG. 2(b), one example of the back side of the smart card of the present invention includes a magnetic medium 12 which stores financial information for consumer and banking transactions. The magnetic medium 12 could, for example, be a strip of magnetic tape that could hold data necessary to execute a financial/banking transaction. The magnetic medium could also be other types of magnetic data storage mean. The smart card 10, in one embodiment of the invention, having the magnetic tape 12, could allow the user to conduct consumer spending transactions without cash similar to the present day Credit Card. For instance, the proprietor of the smart card 10 having the magnetic medium 12 thereon, could purchase consumer products and/or services on credit from a, with credit provided by a particular financial institution. In addition, the financial/banking information stored on the magnetic medium 12 could allow the proprietor of the smart card to conduct banking transactions similar to the present day Debit Card. In other words, one example of the smart card of the present invention could allow the proprietor to withdraw cash, deposit funds, and request for balance, and etc, with any Automatic Teller Machines (ATM), as well as executing a variety of Point of Sale (POS) transactions.

The smart card 10 of the present invention could also be used as a “Virtual Card.” As an example, the microchip 11 embedded in the smart card could also contain at least e-commerce information which could allow the proprietor of the smart card 10 to conduct at least e-commerce transactions on the Internet or the WWW. For instance, such e-commerce transaction could be Business-to-Business (B2B) and/or Business-to-Corporation (B2C) transactions. In other words, one embodiment of the smart card 10 could be used to make purchases of goods and services offered on the Internet or the WWW.

Given the personal and private nature of the medical information contained in one example of the smart card 10, together with the purchasing power of the smart card 10, security features could be placed on and in the smart card 10 and could prevent unauthorized access to the information stored thereon. Additionally, such security features could also prevent the unauthorized use of the smart card 10. One example of such security features is shown on FIG. 2(a) where a graphical depiction 13 of the proprietor's image could be placed on the smart card 10 to authenticate that the user of the card is the actual proprietor authorized to use the smart card to execute various transactions, such as, medical, financial and e-commerce transactions. Another example of such security features could be storing a digital signature of the proprietor on the microchip 11 as a means to verify the signature of the user with the stored digital signature of the proprietor authorized to use the smart card. Accordingly, the microchip 11, as an example, could contain data that could be used to authenticate the identity of the user as well as approving or rejecting the execution of the medical, financial and e-commerce transactions.

FIG. 3 of the drawings shows one example of a smart card 10 for executing various transactions, such as medical, financial and e-commerce transactions 20, 40, 60. One embodiment of the method of executing each of the medical, financial and e-commerce transactions 20, 40, 60 with the smart card 10 is described as follows.

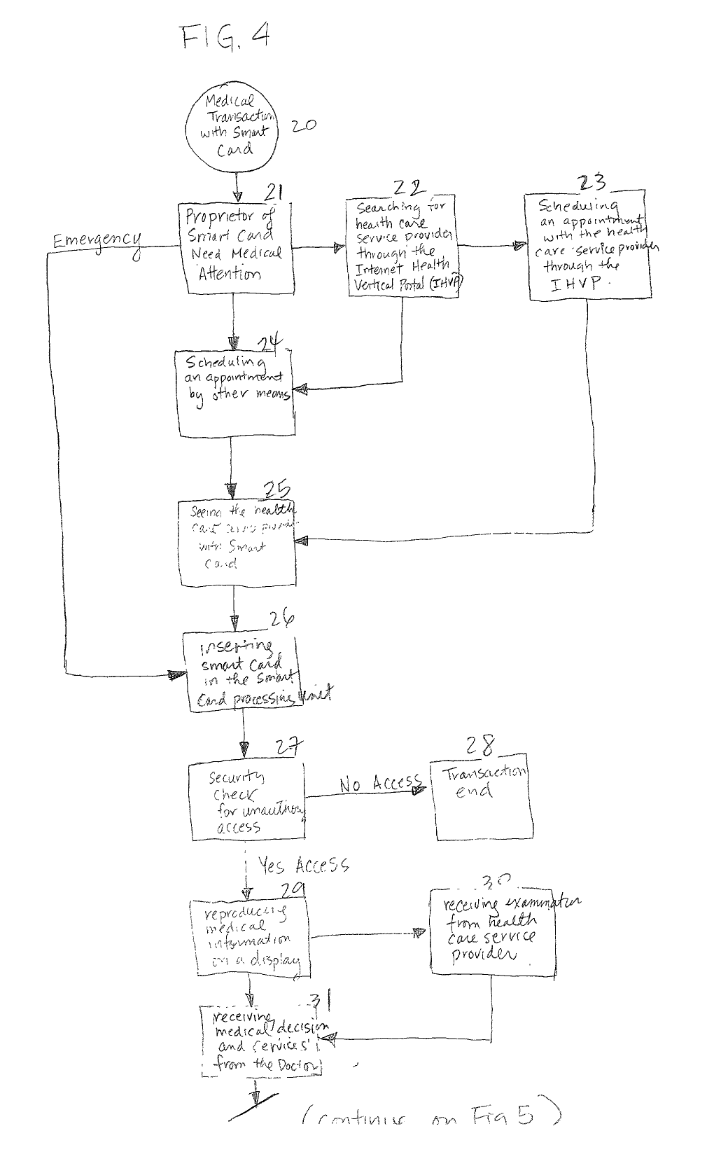

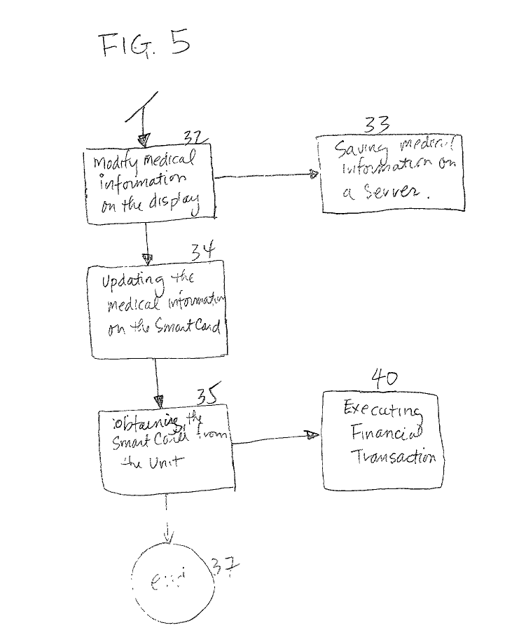

FIGS. 4 and 5 illustrate one example of a method of executing a medical transaction 20 with the smart card 10 in accordance with the present invention. As an example, Block 21 of FIG. 4 describes the step of requiring some type of medical attention by the proprietor of the smart card. For instance, should the proprietor of the smart card becomes sick or ill, or desires a routine check up; the step of needing medical attention 21 arises. Block 24 discloses the step of scheduling an appointment with the physician or the hospital. Typically, the proprietor would telephone the physician's office or the hospital to arrange for a date and time for the appointment. However, the proprietor could also search for a physician and schedule an appointment with a physician on through the Internet Health Vertical Portal (IHVP) configured on the Internet or the WWW, Blocks 22 and 23.

The present invention also could provide the proprietor of the smart card, in one embodiment, access to a location or site on the Internet/WWW containing an Internet Health Vertical Portal (IHVP). This IHVP could provide the proprietor of the smart card a means to the access information on, and services provided by the health/medical community. In addition to searching for a physician and setting an appointment with the physician as disclosed on Blocks 22 and 23 of FIG. 4, the IHVP could provide, as another example, an on-line consultation with an e-doctor, and/or a “Virtual Health Mall” for the purchase of prescription drugs, and etc. with the smart card/Virtual Card.

Block 25 shows the step of attending to the scheduled appointment and arriving at the physician's office or hospital with the smart card 10. Thereafter, the proprietor could present his smart card 10 having at least medical information stored thereon, to the intake staff. The smart card 10 could then be inserted into a input/output receptacle 81 of a Smart Card Processing Unit 80, Block 26.

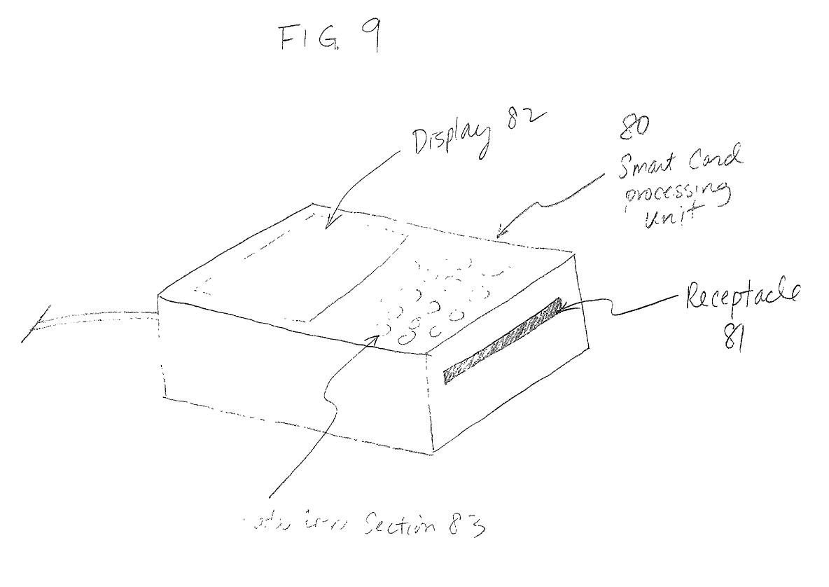

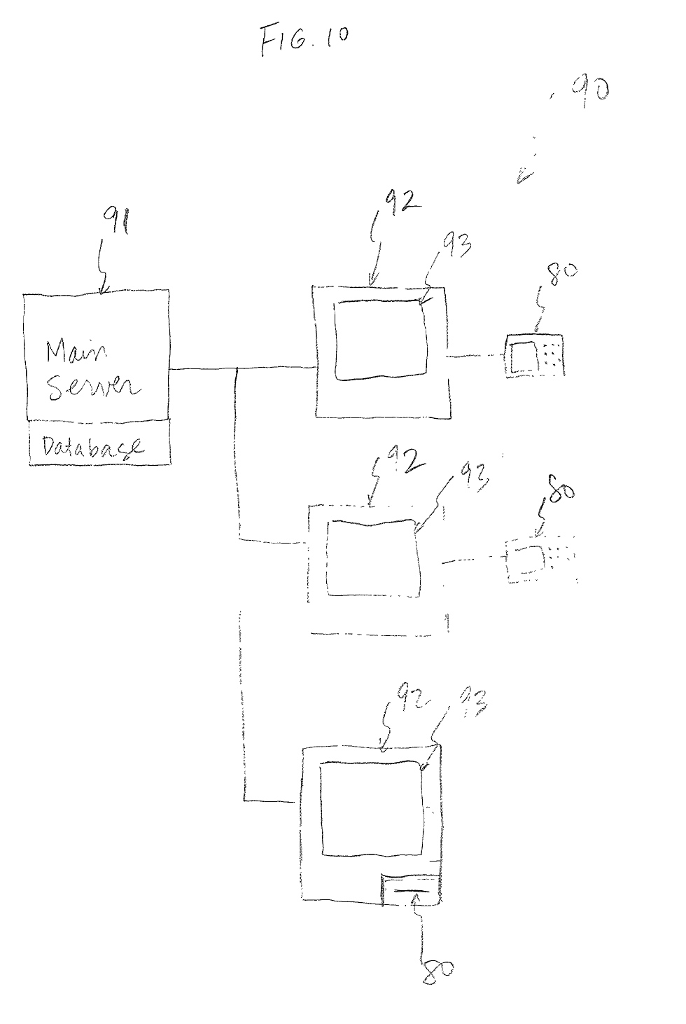

FIGS. 9 and 10 of the drawings show an embodiment of the present invention where each participating medical member of the smart card could be provided with a Smart Card Patient Data System 90 which includes a Smart Card Processing Unit 80. The Processing Unit 80 could read at least the medical information stored on the microchip 11, and could also write data onto the microchip 11. The Smart Card Processing Unit 80 could be incorporated as part of a terminal 92, or could be a separate unit electrically linked to the terminal 92. The Smart Card Processing Unit 80 could be configured be part of a database system having a centralized server 91 which stores the medical records of each patient using the smart card 10. The Smart Card Patient Data System 90 with the centralized server could be used, as an example, for data mining and data warehousing. Software is provided to manage the execution of medical transaction 20 with the smart card 10.

A plurality of security features on the smart card 10 could verify that the intake staff (an employee of the attending physician) could be authorized to access to the medical information stored in the microchip 11, Block 27. In another example, the security features verifies that the card holder is indeed the proprietor of the smart card 10. The verification/security procedure could either be an access code assigned to attending physician/general specialist embedded on the microchip which permits the attending physician/general specialist to automatically access the data upon a match of the access code, or an approval access code could be entered into the Smart Card Processing Unit 80 by the authorized personnel at the time the smart card 10 is inserted therein. Should verification/security procedure fails and an unauthorized access is attempted, the execution of the medical transaction could automatically end, Block 28. Upon authorization, either a copy of the entire medical history of the proprietor, or a portion thereof, could be downloaded from the microchip 11 and reproduced on a display 93 of the terminal 92, Block 29. The physician could review the medical history of the proprietor and examines the proprietor based on the circumstances of the appointment, Block 30. The physician thereafter, could render a medical decision and provide the necessary medical services, Block 31. For example, upon authorization to access the confidential medical information stored on the microchip 11, the physician could select only the medical history files that pertains to the ongoing doctor-patient relationship between the proprietor and the attending physician. After reviewing the selected medical history, the proprietor could advise the physician of the nature of the visit, e.g., pain in the lower back, has a cold, feeling ill and etc. The physician could thereafter examine the proprietor for symptoms and signs to render a medical decision, and could subsequently prescribe medication or additional medical tests. The appointment as well as the services rendered could be recorded on the terminal 92 and the medical information on the display could be updated, Block 32. The updated information could thereafter be stored on a main server 91 located in the physician's office, Block 33; and at the same time the updated information could be written on to the microchip 11 of the smart card 10, Block 34. The smart card 10 could then be retrieved from the Smart Card Processing Unit 80, Block 35. Should payment be necessary at the end of the medical appointment, the proprietor could commence executing a financial transaction with the smart card, Block 40. For example, should the proprietor wish to make a payment for the medical services rendered using the smart card, the proprietor could charge the services with the smart card 10.

The method of executing a medical transaction with a smart card could have other embodiments with respect to the medical/health community which includes, but not limited to medical clinics, private hospitals, public hospitals, medical laboratories, and pharmacies. For example, the method of executing a medical transaction as illustrated in FIGS. 4 and 5 can apply to medical transactions with respect to filling a prescription at a pharmacy, attending a medical clinic or specialist, and especially with respect to a medical emergency situation.

In a medical emergency situation, for example, where the victim looses consciousness, the attending physician, the paramedics, the hospital and/or the medical emergency unit, could instantly obtain the medical history and data stored on the proprietor's/victim's smart card. As shown in FIGS. 4 and 5, the instant the victim loses consciousness, medical attention is required with utmost urgency, Block 21. For example, emergency medical assistance is summoned; and at the arrival of the emergency medical assistance crew (i.e., paramedics), the smart card on the victim's possession allows the paramedics to insert the smart card in a Smart Card Processing Unit 80 available to them, and could have instant access to the victim's medical history, Blocks 26-29. Working with such valuable medical information concerning the victim, the paramedics could render immediate medical decisions to commence resuscitation procedures, and could administer the appropriate medication, Blocks 30-31. For instance, a proprietor of the smart card 10 with a heart condition could have such information stored in the microchip 11 along with information regarding the specific medication the proprietor is administering. Should the proprietor becomes unconscious, the attending medical emergency staff could have access to such medical information from the smart card 10, and therefore, could act accordingly without delay. In addition to the above examples, a proprietor with a bad memory or having memory problems due to old age could rely on the smart card 10 to provide accurate medical information, and safely execute a plurality of medical transactions with the smart card 10.

In addition to the examples of the security features mentioned above and the methods thereof, only the authorized user (owner, physician, hospital, etc.) may access the medical information stored in the microchip. Therefore, if a smart card 10 is stolen or lost, any unauthorized user can not access the medical information stored in the microchip 11, and can not execute a medical transaction 20 with the stolen or lost smart card 10. A duplicate smart card 10 can be immediately issued to replace the stolen or lost card having the exact same information previously stored therein. Moreover, each Smart Card Patient Data System 90 is not linked to the WWW or the Internet, for example, and therefore, the medical records stored in the data system 90 can not be accessed by unauthorized users or hackers.

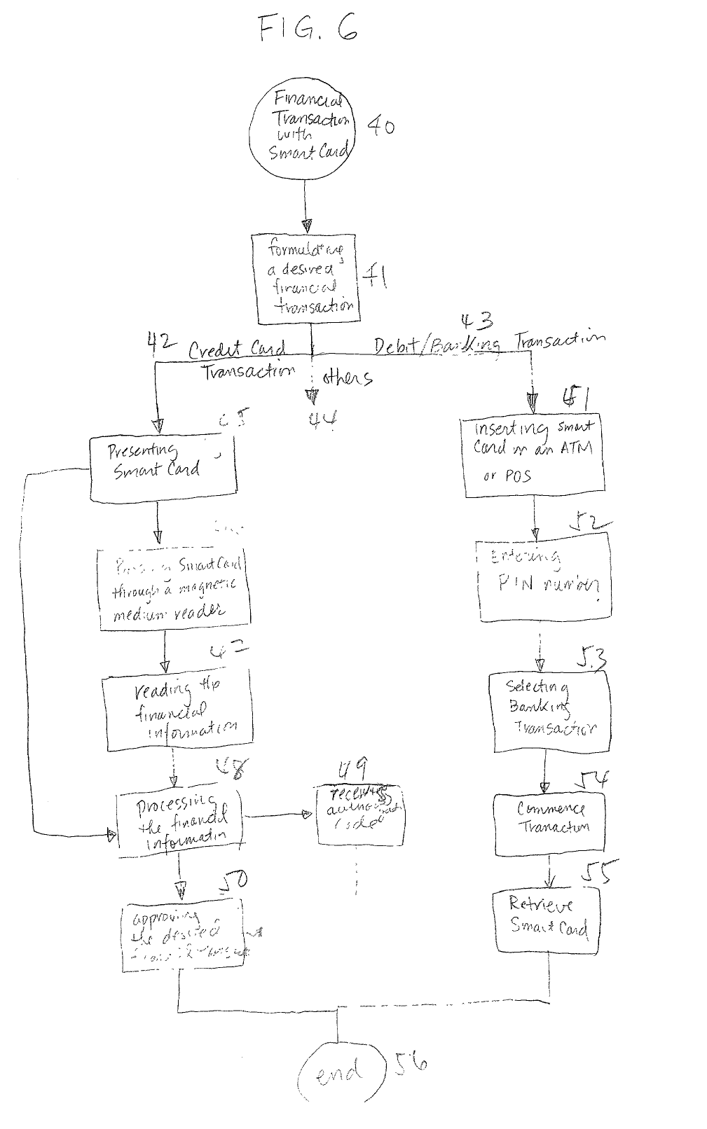

FIG. 6 illustrate one example of a method of executing a financial transaction 40 with the smart card 10 in accordance with the present invention. As mentioned above, an example of the smart card 10 of the present invention includes a magnetic medium 12 which contains at least financial information for executing a plurality of financial/banking transactions. Block 41 of FIG. 6 shows the step of formulating a desired financial transaction. During step 41, the proprietor of the smart card 10 could formulate a decision as to which financial transaction he desires to execute. Branch 42 illustrates that the proprietor has formulated a desired credit card transaction with the smart card 10. Upon formulating such decision, the smart card 10 could be presented to a vendor or a service provider, Block 45; and the smart card 10 could be passed through a magnetic medium reader wherein the reader reads at least the financial information stored on the magnetic medium, Blocks 46 and 47. Thereafter, the financial information could be processed and could be electronically transmitted to obtain approval of the desired financial transaction, Block 48. Approval could be granted by means of transmitting an authorization code, Block 49, in which the desired financial transaction is approved and fully executed, Blocks 50 and 56.

In another embodiment of the present invention, the proprietor could formulate a decision to execute a banking/debit transaction with the smart card 10, Block 43. Upon such a decision, the proprietor could insert the smart card 10 into a receptacle of an ATM, for example. The ATM could read the financial information stored on the magnetic medium 12 and could request for a Personal Identification Number, Block 52. Upon verifying the PIN number, the proprietor could be authorized to continue executing the desired banking/debit transaction. The ATM could display a selection of banking transaction available to the proprietor. The proprietor could select the desired banking transaction from the selection displayed on Block 53. The selected desired banking transaction could be any one or more of the transactions such as, cash withdrawal, deposit of funds, balance inquiry, and etc. Upon achieving the objective of the desired banking transaction, the ATM could terminate the transaction by outputting the smart card 10 which is retrieved by the proprietor, as show in Blocks 55 and 56.

As shown on Block 44 of FIG. 6, the method of executing a financial transaction 20 with the Smart Card 10 can have other embodiments with respect to the financial community.

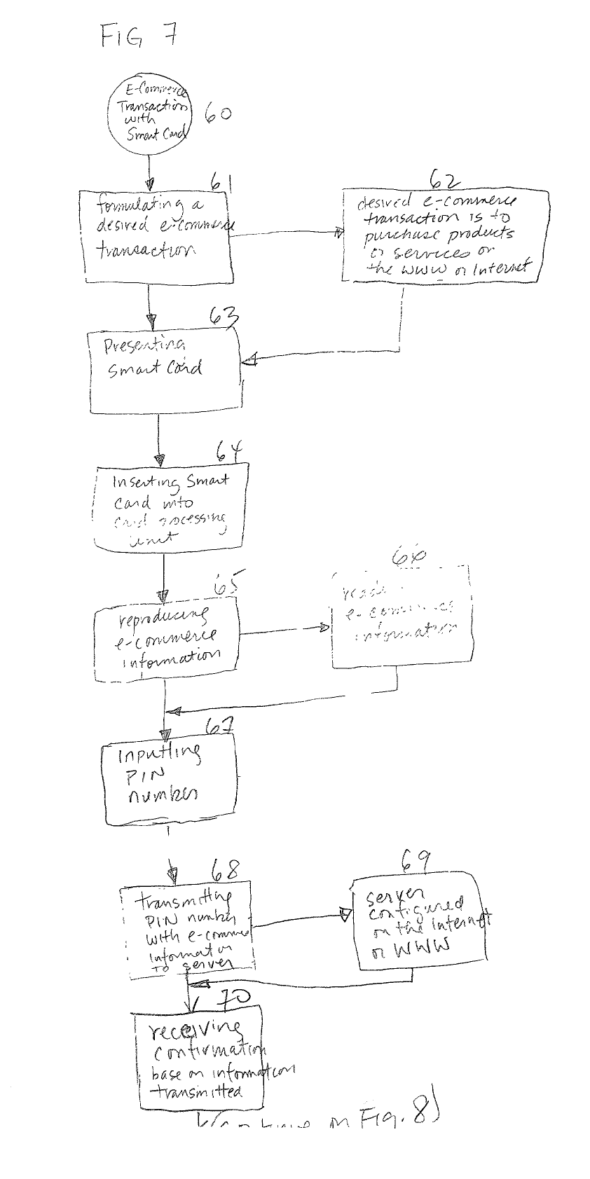

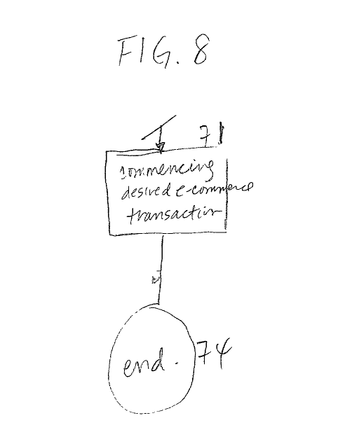

FIGS. 7 and 8 illustrate one example of a method of executing an e-commerce transaction 60 with the smart card 10 in accordance with the present invention. As an example, Block 61 discloses the step of formulating a desired e-commerce transaction. At this step, the proprietor could formulate a decision as to what e-commerce transaction is be to executed. For example, the proprietor could formulate a decision to purchase a product or service on the Internet or WWW either through the IHVP or through an Internet Service Provider. Upon formulating the desired e-commerce transaction, the proprietor could locate the merchandise or service to be purchased, and inserts the smart card/Virtual Card 10 into a Smart Card Processing Unit 80, as shown on FIG. 9, Block 64. The Smart Card Processing Unit 80, for example, could reproduce, by reading, the e-commerce information stored in the microchip 11 on a display. The proprietor could then be asked to enter a PIN number, Block 67. Thereafter, the PIN number could be transmitted to a server, Block 68. In one embodiment, the server could be configured on the Internet or the WWW, Block 69. Upon receipt of the PIN number at the server, a confirmation message could be received by the proprietor, Block 70. Once the confirmation is read and received, the e-commerce transaction commences, Block 71.

The present invention may be embodied in other specific forms without departing from the spirit or essential characteristics thereof. The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

1. A smart card for executing a plurality of transaction types, said smart card comprising:
a card substrate;
a microchip embedded in said card substrate; and
a magnetic medium on said card substrate,
wherein at least one of said microchip and said magnetic medium contains information for executing the plurality of independent transaction types being coordinated through a plurality of vendors of service and products.

2. The smart card of claim 1, wherein said plurality of transaction types includes a medical transaction, a financial transaction, and an e-commerce transaction.

3. The smart card of claim 2, wherein said microchip contains medical information for executing said medical transaction.

4. The smart card of claim 3, wherein said medical information includes medicinal prescriptions.

5. The smart card of claim 2, wherein said microchip contains e-commerce information for executing said e-commerce transaction on the Internet or the World Wide Web (WWW).

6. The smart card of claim 2, wherein said magnetic medium contains financial information for executing said financial transaction.

7. The smart card of claim 1, further comprising:
a graphical depiction of a proprietor placed on said smart card.

8. The smart card of claim 1, wherein said microchip contains security information for prohibiting unauthorized access to said information contained on said smart card.

9. The smart card of claim 8, wherein said security information includes a personal information in the form of a digital signature.

10. The smart card of claim 1, wherein said microchip contains bonus rewards information based on the execution of said plurality of transaction types.

11. A method of executing a plurality of transaction types with a smart card, said method comprising at least the steps of:
executing a first transaction type by,
inserting said smart card into a first receptacle of a first card processing unit,
receiving a first transaction decision based on information of said first transaction type,
obtaining said smart card from said first card processing unit, and
executing a second transaction type by,
formulating a desired second transaction type,
availing information of said second transaction type stored on said smart card,
authorizing the execution of said second transaction type, and
obtaining said smart card, and
executing a third transaction type by,
formulating a desired third transaction type,
inserting said smart card into a second receptacle of a second card processing unit,
viewing information of said third transaction type on a display,
inputting an authenticating code,
transmitting said information of said third transaction type and said authenticating code to a server,
receiving a confirmation of said desired third transaction type, and
retrieving said smart card from said second processing unit.

12. The method of claim 11, wherein the steps of executing said first transaction type further comprises the steps of:
describing a basis for executing said first transaction type, and
receiving said first transaction decision based on information of said first transaction type and said basis for executing said first transaction type.

13. The method of claim 12, further comprises the step of:
executing said first transaction type wherein said first transaction type is a medical transaction.

14. The method of claim 13, wherein the steps of executing said first transaction type further comprises the step of:
availing said smart card to an health care service provider.

15. The method of claim 14, wherein the steps of executing said first transaction type further comprises the step of:
obtaining said smart card from said first card processing unit having updated information of said first transaction type.

16. The method of claim 14, wherein the steps of executing said first transaction type further comprises the step of:
accessing said health care service provider through an Internet Health Vertical Portal (IHVP), wherein said IHVP is configured on the Internet or the WWW.

17. The method of claim 16, wherein the steps of executing said first transaction type further comprises the step of:
scheduling an appointment with said health care service provider via said IHVP.

18. The method of claim 16, wherein the steps of executing said first transaction type further comprises the step of:
scheduling an appointment with said health care service provider.

19. The method of claim 11, further comprising the steps of:
executing said second transaction type wherein said second transaction type is a financial transaction.

20. The method of claim 19, wherein the steps of executing said second transaction type further comprises the step of:
passing said smart card through a magnetic medium reader such that said information of said second transaction type stored on said smart card is read by said magnetic medium reader.

21. The method of claim 20, wherein the steps of executing said second transaction type further comprises the step of:
formulating said desired second transaction type, wherein said desired second transaction type is to purchase a consumer product or service.

22. The method of claim 19, wherein the steps of executing said second transaction type further comprises the steps of:
inserting said smart card in an opening of an Automatic Teller Machine (ATM),
inputting a Personal Identification Number from an input unit of said ATM,
selecting said desired second transaction type from a plurality of second transaction types,
commencing said desired financial transaction type, and
retrieving said smart card from said ATM.

23. The method of claim 11, further comprises the step of:
executing said third transaction type wherein said third transaction type is an e-commerce transaction.

24. The method of claim 23, wherein the steps of executing said third transaction type further comprises the step of:
transmitting said information of said third transaction type and said authenticating code to a server configured on the Internet or the WWW.

25. The method of claim 23, wherein the steps of executing said third transaction type further comprises the step of:
formulating said desired third transaction type wherein said desired third transaction type is to purchase a consumer product or service through the Internet or WWW.
